(19) United States
(12) Patent Application Publication
(10) Pub. No.: US 2014/0020302 A1
(43) Pub. Date: Jan. 23, 2014

(54) PROFILED SEALING SECTION, IN PARTICULAR FOR SEALING A MOVABLE VEHICLE WINDOW PANE

(71) Applicants: Gianfranco Alba, Spichern (FR); Roman Magard, Tholey (DE); Stefan Harig, Losheim (DE); Christian Kast, Merzig (DE); Lukas Nowicki, Heusweiler (DE); Daniel THIEL, Oppen (DE)

(72) Inventors: Gianfranco Alba, Spichern (FR); Roman Magard, Tholey (DE); Stefan Harig, Losheim (DE); Christian Kast, Merzig (DE); Lukas Nowicki, Heusweiler (DE); Daniel THIEL, Oppen (DE)

(73) Assignee: CQLT SAARGUMMI TECHNOLOGIES S.A.R.L., Remich (LU)

(21) Appl. No.: 13/984,349

(22) PCT Filed: Feb. 8, 2012
(86) PCT No.: PCT/EP12/00568

§ 371 Date: Oct. 2, 2013

(30) Foreign Application Priority Data
Feb. 12, 2011 (DE) 10 2011 011 111.5

(51) Int. Cl. B60J 10/04

(52) U.S. Cl. CPC B60J 10/04
USPC 49/495.1

(57) ABSTRACT

A sealing profile section (1), in particular for sealing a movable vehicle window pane (23) on the upper shank of a frame enclosure of a vehicle pane frame, comprising at least one sealing lip (11) that protrudes from a profiled limb (7) of the profiled sealing section (1) at a distance from a neutral bent surface (15) that intersects the sealing profile (1) in the longitudinal direction. The sealing lip (11) is expanded to one side at the sealing lip end facing the profiled limb (7) compared to an initial thickness (S), and a boundary line (14) of the sealing lip (11) cross-sectional area, the boundary line facing away from the side, runs to the free end of the sealing lip in the shape of a sickle.

The invention relates to a sealing profile, particularly for sealing a movable vehicle window pane at the upper shank of a frame enclosure of its frame, having at least one sealing lip that projects away from a shank of the sealing profile at a distance from a neutral bent surface that intersects the sealing profile in the longitudinal direction.

When such a sealing profile, which has a sealing lip disposed at a distance from the neutral bent plane, is laid in bent manner, the danger exists that the sealing lip will assume a wave shape as a result of compression, and will no longer fulfill its sealing function. The wave-shaped sealing lip cannot lie against the sealing object, for example a vehicle window pane, over its entire length, continuously. Furthermore, it impairs the appearance of the sealing profile and might cause wind noises.

The invention is based on the task of creating a new sealing profile of the type mentioned initially, having a sealing lip that is shape-resistant when laid in bent manner.

The sealing profile that accomplishes this task, according to the invention, is characterized in that the sealing lip is widened toward one side, compared with its starting thickness (S), which it demonstrates at its end facing the profile shank, and that the delimitation line of the cross-sectional surface of the sealing lip, which line faces away from this side, runs in sickle-shaped manner toward the free end of the lip.

It is advantageous that a sealing lip formed in this manner retains a cross-sectional shape that is uniform over its length, when the sealing profile is laid in bent manner.

In a preferred embodiment of the invention, the widened part drops from a maximum (S1) to a minimum (S3) toward the free end of the sealing lip, and increases from the minimum (S3) to a further maximum (S2) at the free end of the sealing lip. The widened part therefore preferably comprises a bulge, followed by another maximum, after a minimum, toward the free end of the sealing lip, so that the entire sealing lip is bent away in the manner of a sickle at the free end.

In a particularly preferred embodiment of the invention, the sealing lip has a slide layer on its side facing away from the widened part, whereby this slide layer preferably reaches maximally all the way to a minimal rounding radius at the free end of the sealing lip, i.e. its tip. Because the slide layer is not passed around the tip to the other side of the lip, it cannot promote the formation of a wave shape during bending of the sealing profile.

Preferably, the sealing lip is widened on a side that faces a neutral bent surface of the sealing profile.

The sealing profile is preferably produced from a thermoplastic elastomer, which advantageously allows a reduction in the weight of the sealing profile. On the other hand, without the formation of the sealing lip according to the invention, specifically in the case of a thermoplastic elastomer, there would be the danger that the sealing profile deforms in undesirable manner during bending.

Preferably, the slide layer consists of a thermoplastic, particularly a thermoplastic elastomer, which is harder than the thermoplastic elastomer of the remainder of the sealing profile.

Independent of its material, it is practical if the slide layer is co-extruded with the remainder of the sealing profile.

In a further embodiment of the invention, the profile shank extends perpendicular to the neutral bent surface mentioned above, and the sealing lip stands inclined at a slant away from the profile shank and toward the neutral bent surface.

The invention will be explained in greater detail below, using an exemplary embodiment and the drawings that relate to this exemplary embodiment. The figures show:

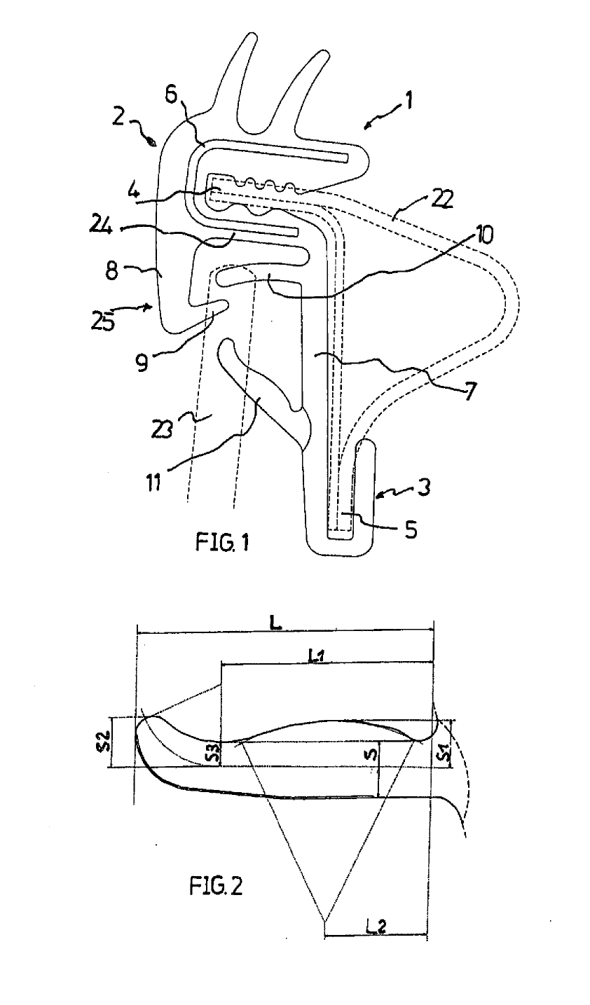

FIG. 1 a cross-section of a sealing profile according to the invention, for sealing a vehicle window pane at an upper shank of a frame enclosure,

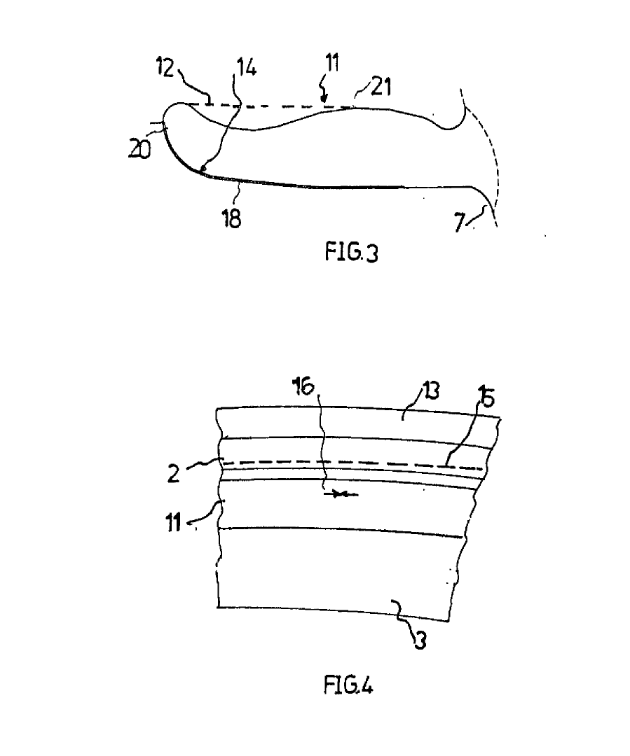

FIGS. 2 and 3 a sealing lip of the sealing profile of FIG. 1, and

FIG. 4 the sealing profile of FIG. 1, as a detail, in a bent side view.

A sealing profile 1 produced from a thermoplastic elastomer serves for sealing a movable vehicle window pane 23 at the upper shank 22 of a frame enclosure, and has fastening sections 2 and 3 for connecting the sealing profile with car body flanges 4 and 5, which are formed on the frame enclosure. The U-shaped fastening section 2, in which a U-shaped metallic reinforcement insert 6 is embedded, can be pushed onto the car body flange 4.

The sealing profile 1 furthermore comprises a U-shaped sealing section 25 having a long profile shank 7, a short profile shank 8, and a transverse shank 24. The transverse shank 24 simultaneously forms a U-shank of the fastening section 2. The upper edge of the window pane 23, indicated by means of broken lines, engages into the U-shaped sealing section 25, parallel to the profile shanks 7, 8.

A sealing lip 9 projects from the short profile shank 8, for making contact against the upper end or the outside of the window pane 23, which can be pressed into the U-profile of the sealing section 25 with its upper edge. Sealing lips 10 and 11, which project away from the long U-shank 7, serve for sealing on the inside of the pane.

The sealing profile 1 shown in FIG. 1 is intended for bent laying according to FIG. 4. A neutral bent surface 15 that intersects the sealing profile 1 in the longitudinal direction is indicated by a broken line. The sealing lip 11 is compressed according to the arrow 16 during bending of the sealing profile 1.

The sealing lip 11, which projects away, inclined at a slant relative to the neutral bent surface 15, from the longer profile shank 7, has a slide layer 18 that is shown in FIGS. 2 and 3. The slide layer 18 consists of a harder elastomer material than the remainder of the sealing profile, and is generally extruded with the remainder of the sealing profile. The slide layer 18 extends on the side of the sealing lip 11 that faces away from the bent surface 15, all the way to a region 20 bent away in sickle shape relative to the neutral bent surface 15, at the free end of the sealing lip 11.

On its side facing the neutral bent surface 15, the sealing lip 11 has a widened part 21 as compared with its starting thickness S, at the end adjacent to the profile shank 7. According to FIG. 2, the widened part 21 increases to a maximum S1, then drops back down to a minimum S3, and finally increases again to a further maximum S3 close to the free end of the sealing lip 11. The following relations apply:

S1>½S (1)

S2>½S (2).

Furthermore, the following apply/applies:

S3≦S1 and/or S3≦S2 (3).

For the equals signs in the relations (3), the lip shape occurs as indicated with a broken line 12 in FIG. 3, with a widened part 21 that continues uniformly all the way to the free end. In every case, the delimitation line 14 of the cross-sectional surface of the sealing lip 11 that lies opposite the widened part 21 runs in sickle shape toward the free end of the sealing lip 11.

For the total length L of the sealing lip 11, the length L1 to the minimum S3 and the length L2 to the maximum S1, the following equations apply:

½L≦L1≦S⅚L (4)

⅙L≦L2≦ 4/6L (5).

When the upper edge of the window pane 23 is pushed into the U-shaped sealing section 25, the sealing lips 9 to 11 are bent away by the window pane 23, toward the neutral bent surface 15. The sealing lip 11 lies against the window pane 23 with its slide layer 18. When the window pane 23 is lowered, the sliding layer 18 ensures that the sealing lip 11 maintains its inclined position relative to the neutral bent surface 15, and does not fold over in the opposite direction. In the exemplary embodiment shown, the slide layer 18 is passed approximately to the minimal rounding radius, i.e. approximately to the tip at the free end of the sealing lip 11, but at least, the slide layer 18 must extend so far toward the end of the lip that no friction occurs between the glass surface and the region of the sealing lip 11 that does not have the slide layer, when the window pane is lowered. On the other hand, the slide layer is not allowed to be passed so far around the tip of the sealing lip 11 that it promotes the formation of wave-like deformations of the sealing lip during bending of the sealing profile.

Despite the bent laying of the sealing strand 1, which is connected with compression of the sealing lip 11, no wave-like deformation of the sealing lip, which would impair the sealing function and/or the appearance of the sealing lip 11, occurs at all. The sealing lip 11 continuously lies against the window pane 23 over its entire length.

The said slide layer 18 could alternatively be formed by a flocking layer or by a film, possibly a flocked film, applied to the extruded sealing profile.

1. Sealing profile (1), particularly for sealing a movable vehicle window pane (23) at the upper shank of a frame enclosure of its frame, having at least one sealing lip (11) that projects away from a shank (7) of the sealing profile (1) at a distance from a neutral bent surface (15) that intersects the sealing profile (1) in the longitudinal direction,
wherein
the sealing lip (11) is widened toward one side, compared with its starting thickness (S), which it demonstrates at its end facing the profile shank (7), and that the delimitation line (14) of the cross-sectional surface of the sealing lip (11), which line faces away from this side, runs in sickle-shaped manner toward the free end of the lip.

2. Sealing profile according to claim 1,
wherein
the widened part (21) drops from a maximum (S1) to a minimum (S3) toward the free end of the sealing lip (11), and increases from the minimum (S3) to a further maximum (S2) a_{t t}he free end of the sealing lip (11).

3. Sealing profile according to claim 2,
wherein
for the maximum (S1) and the further maximum (S2) the following relations apply: S1>½S and S2>½S

4. Sealing profile according to claim 2,
wherein
for the maximum (S1), the further maximum (S2), and the minimum (S3), the following relations apply or the following relation applies: S3≦S1 and/or S3≦S2.

5. Sealing profile according to claim 2,
wherein
the length (L1) from the end of the sealing lip that faces the shank, all the way to the minimum (S3), amounts to minimally ½ and maximally ⅚ of the total length (L) of the sealing lip (11).

6. Sealing profile according to claim 2,
wherein
the length (L2) from the end of the sealing lip (11) that faces away from the profile shank (7), all the way to the maximum (S1), amounts to minimally ⅙ and maximally 4/6 of the total length (L) of the sealing lip (11).

7. Sealing profile according to claim 1,
wherein
the sealing lip (11, 12) is widened only on its side that faces the neutral bent plane (15).

8. Sealing profile according to claim 1,
wherein
the sealing lip (11, 12) has a slide layer (18) on its side facing away from the widened part (21).

9. Sealing profile according to claim 8,
wherein
the slide layer (18) reaches maximally all the way to a minimal rounding radius at the free end of the sealing lip (11).

10. Sealing profile according to claim 1,
wherein
the sealing profile (1) is produced from a thermoplastic elastomer.

11. Sealing profile according to claim 8,
wherein
the slide layer (18) consists of thermoplastic, particularly a thermoplastic elastomer, which is harder than the thermoplastic elastomer of the remainder of the sealing profile (1).

12. Sealing profile according to claim 8,
wherein
the slide layer (18) is co-extruded with the remainder of the sealing profile (1).
